(19) United States
(12) Patent Application Publication
(10) Pub. No.: US 2019/0301915 A1
(43) Pub. Date: Oct. 3, 2019

(54) VALVE ASSEMBLY AND DISPENSING SYSTEM

(71) Applicant: Reagent Chemical & Research, Inc., Ringoes, NJ (US)

(72) Inventors: DONALD W. SONNTAG, Carl Junction, MO (US); Michael L. Shackelford, Joplin, MO (US); Howard A. Vanfleet, Duenweg, MO (US)

(21) Appl. No.: 15/937,183

(22) Filed: Mar. 27, 2018

(51) Int. Cl. G01F 11/38; G01F 15/00

(52) U.S. Cl. CPC G01F 11/38; G01F 15/005

(57) ABSTRACT

An improved valve assembly having a material inlet, a metering chamber and a port. A valve element reciprocates within a valve passageway, such that in a first condition, a flow path is created for material to flow from the inlet to the metering chamber and the valve element forms a metal-to-metal seal of the flow path to the discharge port. The valve element then slides to the second condition, to unseal the passageway to the discharge port, and forms a metal-to-metal seal of the flow path to the inlet. A piston forces the material out of the metering chamber, and because the flow path to the discharge port is unsealed and the flow path to the inlet is sealed, the material is directed from the metering chamber, to the discharge port, where it can be dispensed as desired.

### BACKGROUND OF THE INVENTION

The invention relates generally to machines for dispensing high viscosity materials and more particularly, to improved valve designs to help those machines operate more efficiently.

A variety of valve systems have been employed in automated processing equipment to dispense metered quantities of materials, among which are included solid, liquid and even gaseous materials. One of the more difficult problems facing the dispensing industry has been the metered dispensing of viscous materials. These materials, while flowable, are difficult to handle. A particular problem resides in their relatively high viscosity and surface tension. The materials tend to cling together and to the dispensing equipment with which they are associated.

Examples of viscous materials for which accurate dispensing remains an issue may be found in the food industry and include such viscous products as butter, peanut butter, jams, and cheeses. In the cosmetic industry, these viscous materials can include thick lotions, gels, creams and the like. Household chemicals include such diverse products as caulk, silicone adhesive, sealant, shoe polish, greases, and hand cleaners. Industrial chemicals include greases and other petroleum products, sealants, adhesives, and a host of others. All of these industries experience difficulties with automated packaging equipment due to the difficulties encountered while dispensing high viscosity materials.

One example of a metering valve apparatus used in the food industry is described in U.S. Pat. No. 2,649,996, incorporated herein by reference. A dual dispensing valve system employs specially constructed piston heads as part of the valve structure to produce a section at the end of respective dispensing nozzles, so that material clinging to the end of a nozzle is drawn back into the valve or discharge conduit. Other examples of valve systems which utilize this “snuff-back” feature to reduce spillage or dripping are shown in U.S. Pat. No. 3,731,716 and U.S. Pat. No. 3,717,284, also incorporated herein by reference.

A dispensing valve assembly and system is also disclosed in U.S. Pat. No. 4,974,755, the contents of which are incorporated herein by reference. The valve assembly includes a dispensing valve including a valve casing having an interior chamber. An inlet intersects the valve passageway and connects to a source of material to be dispensed. The system includes a valve element that is received in the passageway. Seals are provided and the valve element reciprocates over a cycle, with the seal elements constraining the flow of material, so that it is directed in the desired direction, without undue leakage.

Valve assemblies and systems for dispensing high viscosity materials have drawbacks. For example, many machines including these assemblies have proved to be insufficiently reliable and can be overly prone to breakdown or to require excessive maintenance.

Accordingly, in improved valve assembly and dispensing system is desired, which overcomes drawbacks of the prior art.

### SUMMARY OF THE INVENTION

Generally speaking, in accordance with the invention, an improved valve assembly is provided, having a material inlet, a metering chamber and a port to a discharge chamber. A valve element reciprocates within a valve passageway, such that in a retracted condition, a flow path is created for material to flow from the inlet to the metering chamber, but the valve element seals the flow path to the discharge port. The valve element then extends, to unseal the passageway to the discharge port, but seals the flow path to the inlet. A piston forces the material out of the metering chamber, and because the flow path to the discharge port is unsealed and the flow path to the inlet is sealed, the material is directed from the metering chamber, to the discharge port, where it can be dispensed as desired.

The seal between the metering chamber and the discharge port is a metal-to-metal seal, having appropriate smoothness, length and/or angle to the longitudinal axis of the flow passageway and valve element, to prevent leakage. A metal-to-metal seal is also present to seal the flow path from the metering chamber to the material inlet. The metal-to-metal seal has been determined to provide advantages in terms of maintenance and reliability. Sensors should be present to monitor the position of the valve element and a piston that retracts to draw material into the metering chamber and then forces that material out of the metering chamber and into the discharge chamber.

Accordingly, it is an object of the invention to provide an improved valve assembly, dispensing unit and method of operating the valve assembly and dispensing unit.

Still other objects of the invention will in part be obvious and will, in part be apparent from the specification and drawings. The invention accordingly comprises the apparatus and method of operation which will be exemplified in the structures and methods hereinafter described, and the scope of the invention will be indicating the claims.

### BRIEF DESCRIPTION OF THE DRAWINGS

For a fuller understanding of the invention, reference is had to the following description, taken in connection with the accompanying drawing, in which:

FIG. 1 is a side view of a valve assembly in accordance with a preferred embodiment of the invention;

FIG. 2 is a cross-sectional view of the valve assembly of FIG. 1;

FIG. 2A is an enlarged view of a portion of the valve assembly depicted in FIG. 2;

FIG. 3 is a cross-sectional view of the valve assembly of FIG. 1, in the material discharging condition;

FIG. 3A is an enlarged portion of the valve assembly of FIG. 3;

FIG. 4A is cross-sectional view of the valve assembly of FIG. 1 in the metering chamber filling condition;

FIG. 4B is a cross-sectional view of the valve assembly of FIG. 1 in an intermediate condition;

FIG. 4C is a cross-sectional view of the valve assembly of FIG. 1 in a material dispensing condition;

FIG. 4D is a cross-sectional view of the valve assembly of FIG. 1 in an intermediate condition;

FIG. 4E is a cross-sectional view of the valve assembly of FIG. 1 in the condition prior to filling the metering chamber;

FIG. 4F is a cross-sectional view of the valve assembly of FIG. 1 in a condition just prior to filling the metering chamber;

FIG. 4G is an enlarged portion of the valve assembly of FIG. 4B; and

FIG. 5 is a schematic diagram of a system for controlling the valve assembly. As used herein, like reference numerals will be used to indicate similar elements. The features depicted in the drawings are not necessarily drawn to scale.

### DETAILED DESCRIPTION OF THE PREFERRED EMBODIMENTS

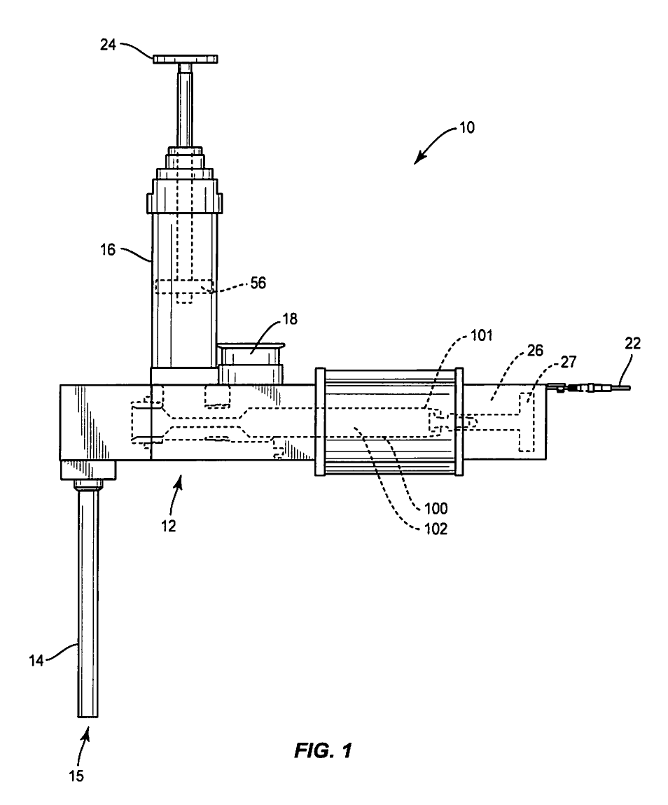

A dispensing apparatus, in accordance with one preferred embodiment of the invention, is shown generally in FIGS. 1-4F as a valve assembly 10. Valve assembly 10 includes an inlet supply conduit 18 for supplying the material to be dispensed. Valve assembly 10 includes a dispensing valve 12 for controlling the flow of the material; a discharge nozzle 14 for dispensing the material into a container; and a metering cylinder 16 for collecting a metered amount of the material to be dispensed. Valve assembly 10 is particularly well suited for dispensing metered amounts of a high viscosity material, such as caulk, adhesive, putty, peanut butter, paint and so forth. For example, valve assembly 10 is well suited to dispense materials having a viscosity over 10,000 cp, preferably over 50,000 and even 100,000 cp. On the other hand, it can be used to dispense metered amounts of many different types of material, regardless of viscosity.

An inlet supply conduit 18 can be in communication with an upstream source of the material to be dispensed (not shown). Dispensing valve 12 is preferably located downstream of conduit 18 and receives the material from conduit 18, as described more thoroughly below. Nozzle 14 has an interior 15, defining a discharge flow path through which the material is to be dispensed.

Metering cylinder 16 is mounted in fluid communication to dispensing valve 12. A metering piston 56 retracts in metering cylinder 16 to draw the material into cylinder 16. A drive mechanism 24, such as an air cylinder, is mounted to metering cylinder 16 to provide force to metering piston 56. Other sources of force, such as a servo motor or a hydraulic drive can be used to reciprocate piston 56 in cylinder 16.

Dispensing valve 12 includes a valve element 100, described more thoroughly below. Valve element 100 is preferably a one piece element, but can be formed in two or more pieces, joined as one or separated. Valve element 100 includes a base drive shaft 102, which is connected to an air cylinder 26, having an air supply 22 and a piston 27, which is connected to and applies force to a proximal end 101 of valve element 100. Other sources of force, such as a servo motor or hydraulic drive can also be used to reciprocate valve element 100 within dispensing valve 12. Metering cylinder 16 can include position sensors (not shown), to insure proper positioning of piston 56. The sensors can send signals to a microprocessor to control function and displacement of piston 56 to electronically adjust the volume of the product to be dispensed. Likewise, air cylinder 26 can have position sensors (not shown) to help properly position piston 27 and valve element 100. Signals from these sensors can also be sent to a microprocessor.

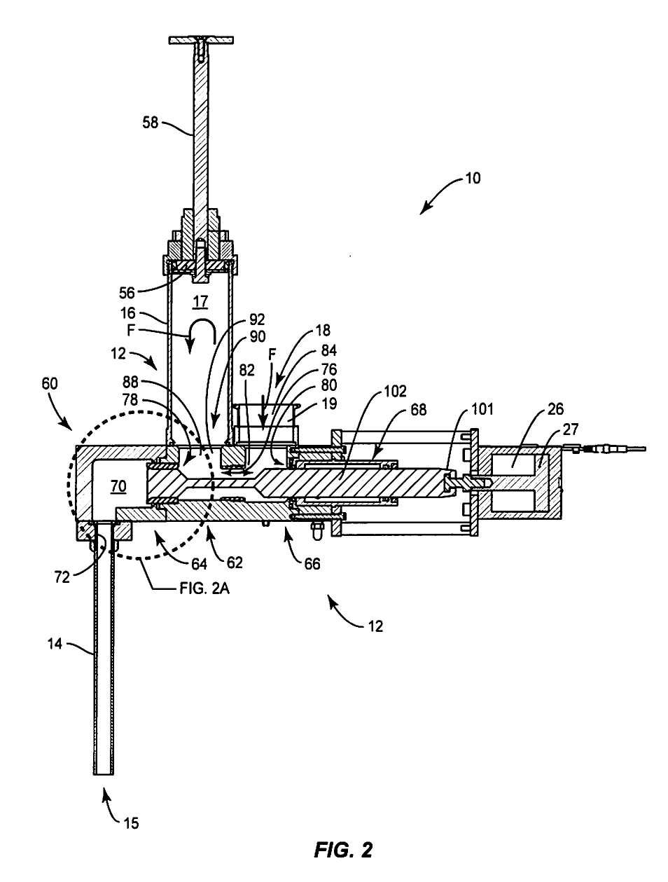

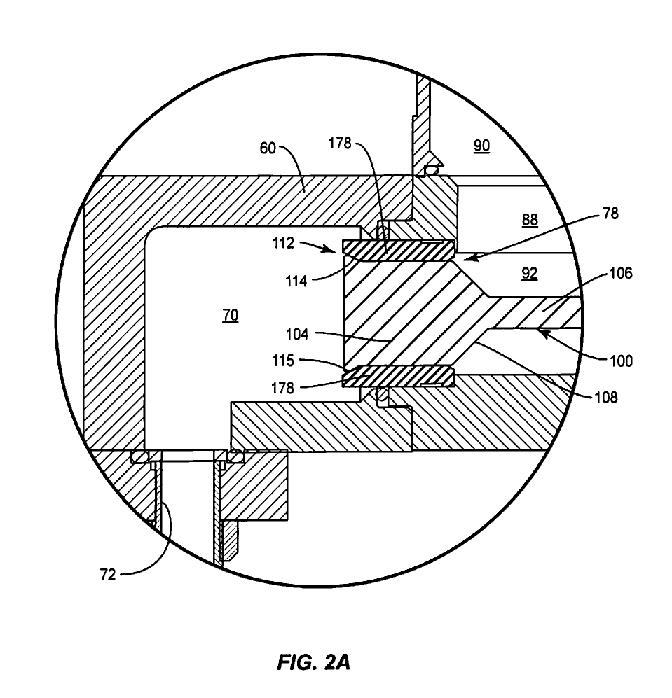

As shown in FIG. 2, dispensing valve 12 includes a valve body or casing 60, which is formed as a plurality of casing sections. More specifically, valve casing 60 includes a nozzle section 64 at a distal end, where the material is dispensed, a meter section 62 adjacent nozzle section 64, an inlet section 66 adjacent meter section 62 and a rear seal section 68 at the proximal end. Meter section 62 mounts metering cylinder 16. Nozzle section 64 mounts nozzle 14 and has an internal dispensing chamber 70, which communicates with a dispensing port 72, located between internal chamber 70 and nozzle 14. Inlet section 66 mounts conduit 18 for supplying material to valve assembly 12. Rear seal section 68 is mounted to inlet section 66 opposite meter section 62 and acts as a seal and guide for drive shaft 102 of valve element 100.

A valve passageway 76 is formed longitudinally from rear seal section 68 to nozzle section 64, through meter section 62 and inlet section 66 of valve casing 60 along the axis of valve element 100. Valve passageway 76 has a first opening 78 at its distal end, defined by a stop insert 178, described below. When not sealed, first opening 78 permits material to flow between dispensing chamber 70 and meter section 62. Valve passageway 76 has a second opening 80 at the proximal end of inlet section 62 and at the distal end of rear seal section 68. Drive shaft 102 passes through second opening 80, into and out of rear seal section 68 as it reciprocates during use.

A material inlet port 82 is formed in inlet section 66 and can extend transversely with respect to valve passageway 76, at an exterior inlet opening 84. Inlet conduit 18 has an interior 19, which is in fluid communication with inlet port 82 when conduit 18 is mounted to dispensing valve 12. Similarly, a metering port 88 is formed through meter section 62, transversely to valve passageway 76 and is in communication with valve passageway 76. Metering port 88 extends from an exterior metering opening 90 to an interior metering opening 92. Metering port 88 is also in communication with interior 17 of metering cylinder 16, so that the material can flow through meter section 62, into and out of metering cylinder 16.

Metering cylinder 16 includes metering piston 56, which is slidably mounted in interior 17 and connected to a piston rod 58 for mechanical movement thereof under air power or another power source. Inlet port 82, valve passageway 76, dispensing chamber 70 and dispensing port 72 define a flow path for material to be dispensed from an upstream location at exterior opening 84 to a downstream location at dispensing port 72 in the directions of an arrow F.

To dispense the material, as described more fully below, valve element 100 retracts in passageway 76. This seals first opening 78 and opens a passageway from material inlet conduit 18 to metering cylinder 16. Then, piston 56 retracts and the material flows through inlet port 82 to fill interior 17 of metering cylinder 16. Valve element 100 then extends to seal inlet port 82 from dispensing chamber 92. Valve element 100 continues to extend and unseals first opening 78. Valve element 100 and valve casing 60 are preferably configured and arranged such that first opening 78 and inlet port 82 are not both open at the same time. Thus, flow will not occur through both openings at the same time. Then, piston 56 extends and the material exits metering cylinder 16, into dispensing chamber 70 and nozzle 14.

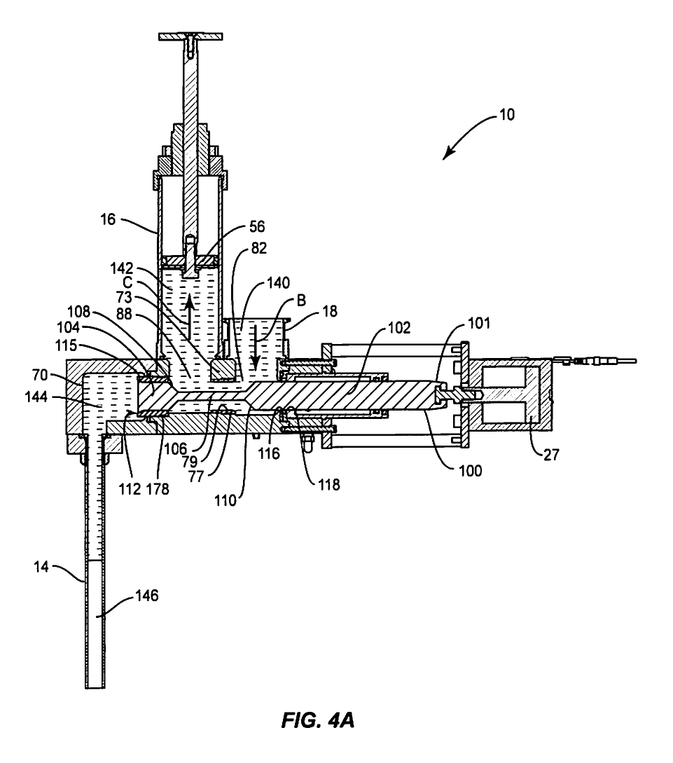

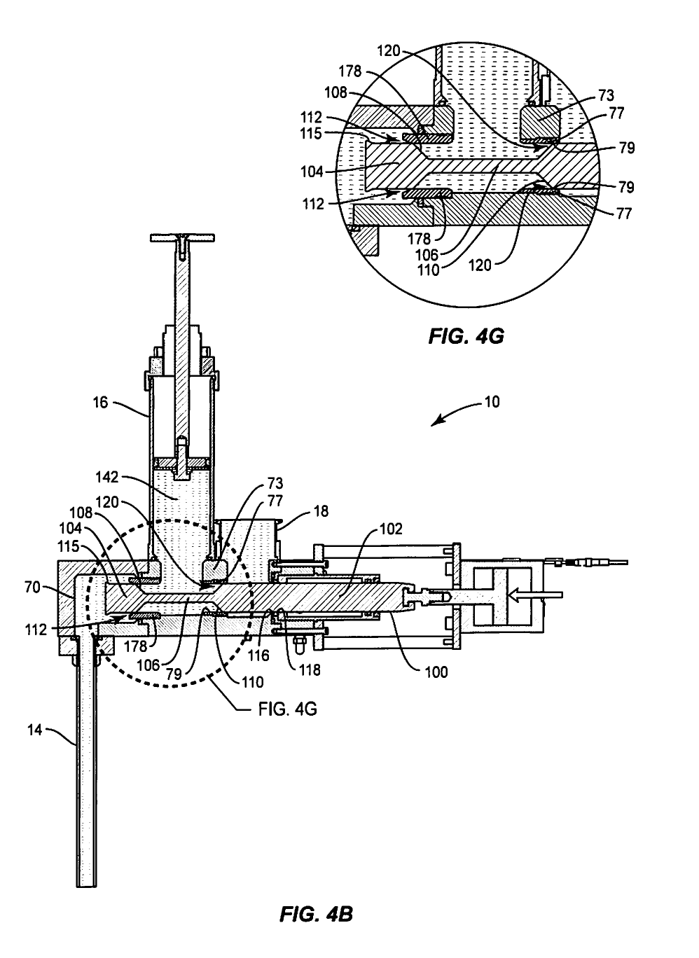

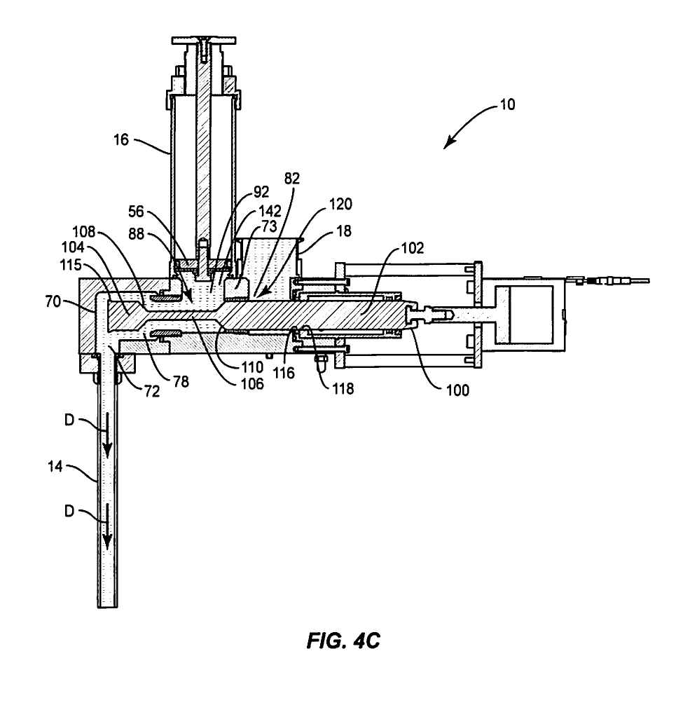

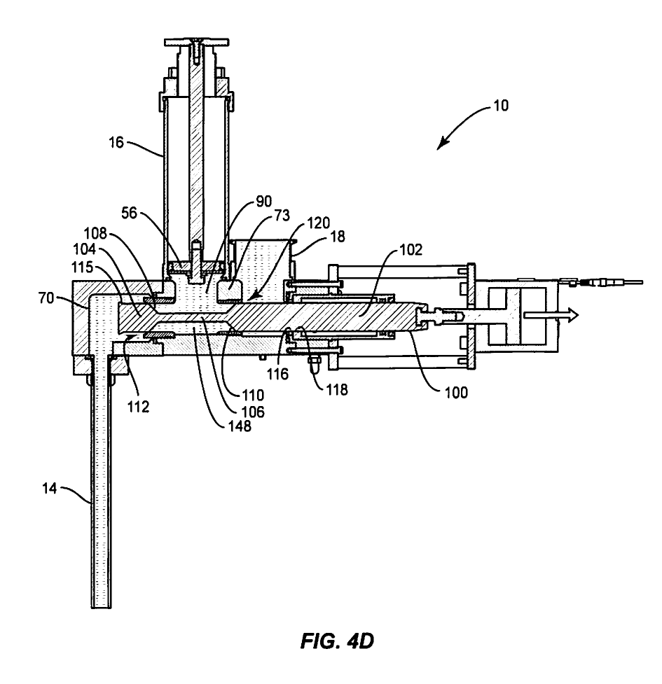

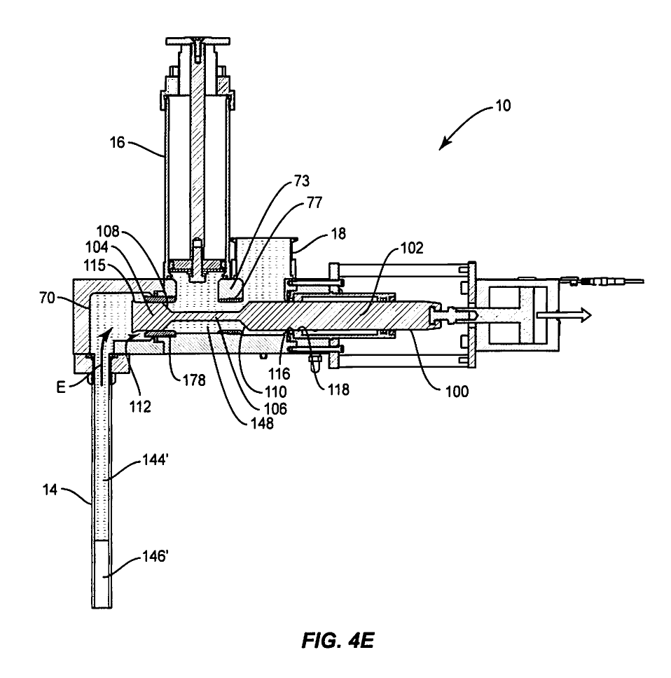

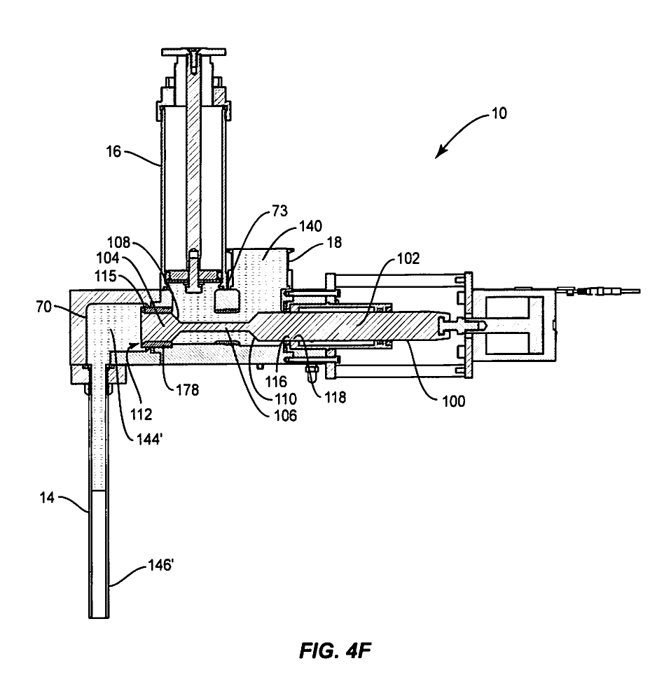

Valve element 100 and its operation are shown in FIGS. 4A-4F. Valve element 100 includes drive shaft portion 102, an elongated piston head portion 104 and a waisted portion 106, which has a reduced cross-sectional diameter. Waisted portion 106 connects drive shaft 102 and piston head 104. Preferably, valve passageway 76 is cylindrical in shape so that it has a circular cross-section, and valve element 100 is preferably formed out of a cylindrical rod that is milled for close fitting, sliding, reciprocal movement in valve passageway 76. However, other embodiments will be apparent. A pair of opposite ends 108 and 110 of waisted portion 106 have an optional frustoconical shape, to assist with smooth movement in passageway 76. Other characteristics and dimensions of valve element 100 will be described more fully below.

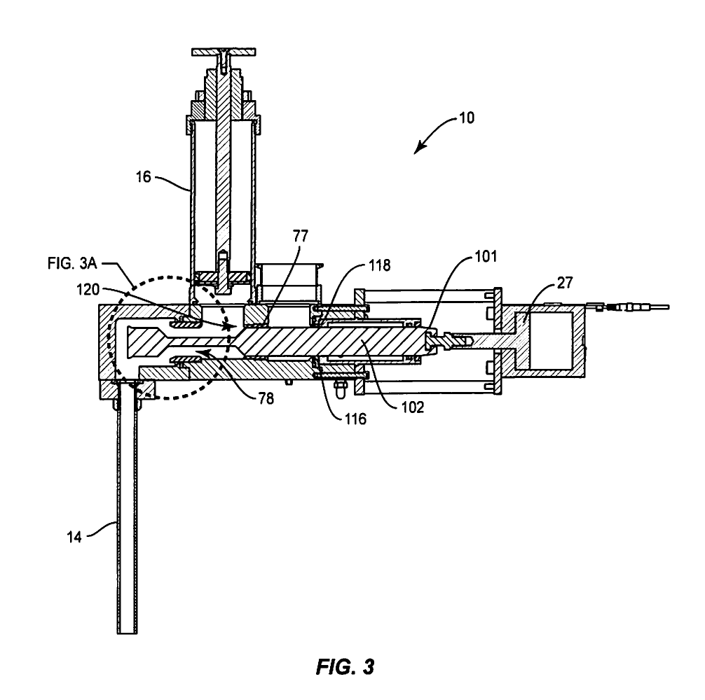

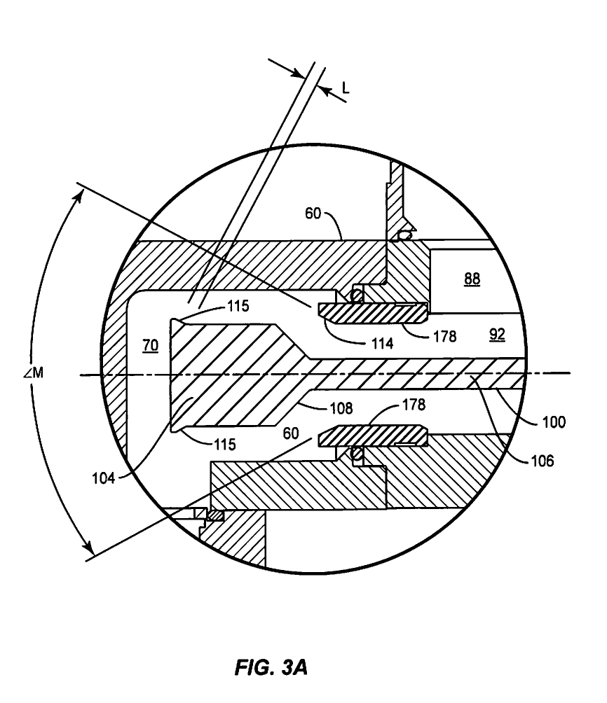

Referring to FIGS. 2A and 3A, it can be seen that a first seal 112 is formed by the metal-to-metal engagement between a circumferentially inclined (frustoconical) stop face 114 extending around the interior of stop insert 178 at first opening 78 and a frustoconical seating face 115, flaired around the exterior of the distal end of head 104.

Referring to FIG. 3, a second seal 116, for example, a polypak seal, is mounted in a circumferential channel 118 formed in the surrounding sidewall of valve passageway 76 proximate second opening 80.

A third seal 120 (see, e.g., FIG. 4G) is formed by the close tolerances of the metal-to-metal engagement of the outer surface of drive shaft 102 and a carefully dimensioned inner surface 79 of a drive shaft insert 77 formed in a surrounding sidewall 73 of passageway 76 between inlet port 82 and interior metering opening 92. Thus, drive shaft insert 77 defines a belt section between meter section 62 and inlet section 66. This clearance seal is created by dimensioning the gap between shaft 102 and inner surface 79 to be less than about 0.060 inches, preferably about 0.0005 inches min. to 0.025 inches max, more preferably 0.0005 inches to 0.01 inches.

Inner surface 79 is preferably formed on a hardened, replaceable insert 77. The material and hardness of insert 77 can be the same as valve element 100. Preferably, insert 77 and/or valve element 100 are formed from stainless steel with a Rockwell hardness over about 20 Rc, preferably at least about 42. Insert 77 can seat to a housing shoulder in passageway 76 and can be retained by setscrews or a locking pin. The seating and sealing surfaces on valve element 100 and/or insert 77 are preferably machined and polished to at least about a 24 RMS finish, preferably at least about a 16 RMS finish.

Metal-to-metal seal 112 is formed with similar materials. For example, replaceable insert 178 is preferably formed from stainless steel with a Rockwell hardness of at least 20, preferably at least about 42. Insert 178 can seat to a housing shoulder and can be retained by setscrews or a locking pin. The seating and sealing surfaces on insert 178 are preferably machined and polished to at least about a 24 RMS finish, preferably at least 16 RMS.

The operation of valve assembly 10, including dispensing valve 12, can be shown with references to FIGS. 2, 3 and 4A-4G. Dispensing valve 12 is movable between the fully closed position of FIG. 2 and the fully open position shown in FIG. 3. To this end, valve element 100 is slidably mounted in valve passageway 76 for reciprocal longitudinal movement therein. However, valve element 100 should be sized and configured so that seals 112 and 120 are not open at the same time.

As is shown in FIG. 4A, valve element 100 is sealed by first metal-to-metal seal 112 and by polypak seal 116. Waisted portion 106 has a greater longitudinal length than the longitudinal distance between inlet port 82 and metering port 88. Therefore, as piston 56 retracts, a quantity of a viscous material 140 can flow past surface 79 of insert 77, alongside waisted portion 106, in the directions of arrows B and C. Thus, material 140 flows into metering cylinder 16 as a selected measured quantity 142. An undispensed portion 144 of the material is located in chamber 70 and partially in nozzle 14, leaving a void 146.

After metering cylinder 16 is filled with selected quantity 142, valve element 100 extends to the position shown in FIGS. 4B and 4G. Frustoconical portion 110 facilitates movement of valve element 100 into engagement of third seal 120 so that drive shaft 102 becomes sealed by surface 79. Similarly, piston head 104 advances into chamber 70, but remains partially sealed against insert 178, because waisted portion 106 has a longitudinal length less than the distance between insert 178 and insert 77. Both piston head 104 and drive shaft 102 form seals, and metered material 142 cannot exit metering cylinder 16. However, due to the displacement of material in chamber 70 by the advancement of piston head 104, undispensed portion of material 144 is displaced by piston head 104 so that it fills former void 146 in nozzle 14.

Next, valve element 100 continues to advance to the fully open position shown in FIG. 4C wherein piston head 104 moves out of a sealed relationship with seal 112. Metered material 142 is forced by metering piston 56 out of metering cylinder 16, and the selected quantity of metered material is dispensed in the direction of an arrow D, through dispensing chamber 70 and nozzle 14. This is accomplished because waisted portion 106 has a longitudinal length greater than the distance between metering port 88 and first opening 78. This allows metered material 142 to flow out of metering port 88 through valve passageway 76 alongside waisted portion 106, into chamber 70 and out of dispensing port 72.

After metered quantity of material 142 is dispensed, valve element 100 is caused to return in the retracted path, as is shown in FIGS. 4D to 4F. First, valve element 100 starts to retract to a position where piston head 104 and drive shaft 102 are respectively sealed by first seal 112 and third seal 120. This position is identical to that shown in FIG. 4B except that metered material 142 has been discharged from metering cylinder 16, such that metering piston 56 is located proximate exterior metering opening 90. As valve element 100 continues to retract to the position shown in FIG. 4E, piston head 104 begins to create a negative pressure in chamber 80 so that the undispensed portion of the material 144′ is drawn or “snuffed back” into chamber 70 in the direction of an arrow E, leaving a partial void 146′. Prior to the unseating of drive shaft 102 from third seal 120, the volume of the remaining material 148 in metering section 62 is unchanged due to the common cross-section of piston head 104 and drive shaft 102.

As is shown in FIG. 4F, valve element 100 continues to retract until it reaches the fully closed position, similar to FIG. 4A, except that in FIG. 4F, viscous material 140 is shown in a position to begin filling metering cylinder 16. In the position shown in FIG. 4F, the undispensed portion 144′ has been drawn back into chamber 70 so that void 146′ is created. The volume of voids 146 and 146′ are each equal to the volume of piston head 104 that is removed from chamber 70 after piston head 104 seals against insert 178. This withdrawal of material from nozzle 14 helps prevent unwanted drips or spillage as it provides both a clean cut-off for the undispensed material and accurate measurement of dispensed material. To this end, it is desirable that the volume of piston head 104 be equal to or greater than the volume of both dispensing port 72 and interior 15 of nozzle 14.

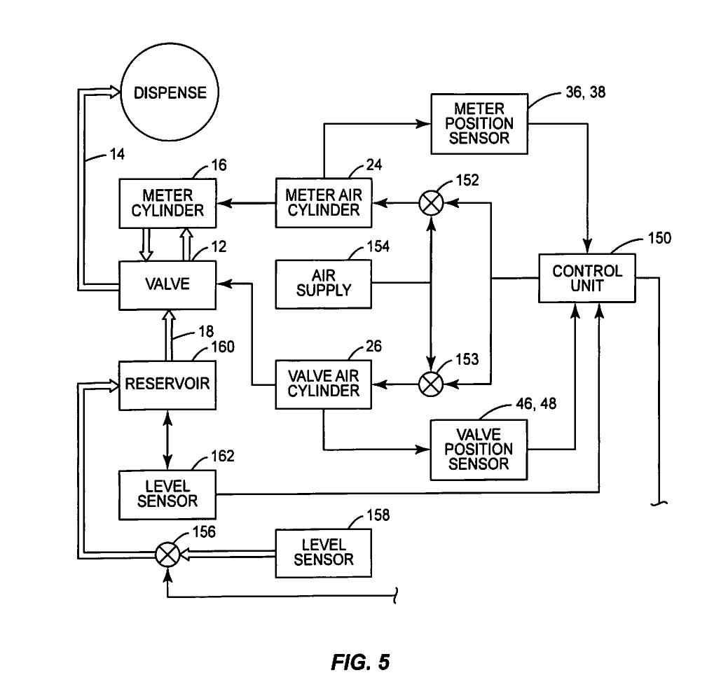

FIG. 5 shows a diagrammatic view of a dispensing apparatus and system in accordance with a preferred embodiment of the invention. A control unit 150, such as a microprocessor, controls a material valve 156, so as to control a supply of material from a source 158 to a reservoir 160. To this end, reservoir 160 has a level sensor 162 which provides a signal to control unit 150 to control the amount of material in reservoir 160, so that control unit 150 can open and close valve 156 to supply material to reservoir 160, so that it stays within prescribed boundary limits. Reservoir 160 is then connected to conduit 18 that supplies the source of material to valve 12.

Similarly, control unit 150 controls a pair of three-way air valves 152 and 153 so that pressurized air from a pressurized air supply 154 is selectively provided through appropriate conduits to meter air cylinder 24 and valve air cylinder 26. To this end, control unit 150 monitors the condition of air cylinders 24 and 26, respectively, through a pair of position sensors 36, 38 and a pair of sensors 46, 48. Control unit 150 then operates valves 152 and 153 so that pressurized air to valve air cylinder 26 reciprocates valve element 100 and so that pressurized air to air cylinder 24 reciprocates meter piston 56.

In order to lubricate and clean drive shaft 102 during use with a viscous material, a wick, preferably constructed of a felt material, can be mounted in a circumferential groove around shaft 102 and can be in fluid communication through a port with a reservoir of cleaner/lubricant selected to be compatible with the material to be dispensed. An O-ring seal can retain the cleaner/lubricant to prevent ingress of unwanted containments. Finally, a rod wiper can be used to clean drive shaft 102.

It has been determined that considerable improvements in reliability and reduction in maintenance cost can be obtained by employing a metal-to-metal seal at the first and second seals 112 and 120. Thus, seating face 115 meets circumferential stop 114 in an inclined relationship. Preferably, circumferential stop 114 and seating face 115 are inclined at an angle M, shown in FIG. 3A that should be between about 15° to 85°, preferably 30° to 80°, more preferably 45° to 75° to the longitudinal axis of valve element 100. In addition, the length of the engagement where stop 114 meets seat 115 (length L of FIG. 3A) where seating face 115 meets stop 114 when valve element 100 is fully retracted is preferably over 0.01 inches, e.g., about 0.01 to 0.7 inches, more preferably 0.125 to 0.5 inches, most preferably about 0.25 to 0.5 inches.

It will thus be seen that the objects set forth above, among those made apparent from the preceding description, are efficiently attained, and, since certain changes may be made in carrying out the above method and in the compositions set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed is:

1. A valve assembly for dispensing a metered quantity of flowable material, comprising:
a material conduit formed with metal and having a proximal end and a distal end opposite the proximal end, the conduit including a first opening distal the proximal end, a second opening distal the first opening, a belt section between the first and second openings, a neck section distal the second opening and a third opening, distal the neck section;
the first opening adapted to receive a flow of the material to be dispensed;
the second opening in fluid communication with a metered container adapted to receive and dispense a selected volume of the material;
a valve element formed with metal, slidably disposed within the conduit, and selectively displaceable between a proximal retracted position and a distal extended position, the valve element having a base portion with an outside diameter matching the inside diameter of the belt section of the conduit, a waist portion of reduced diameter distal the base portion and a head portion distal the waist portion, the outside diameter of the head portion matching the inside diameter of the neck section of the conduit;
the valve element and conduit adapted and configured such that when the valve element is in the retracted position, the head portion forms a metal-to-metal first seal with the neck, such that material forced through the first opening, into the conduit, will be directed to flow into the metered container and not past the first seal and when the valve element is in the extended position, the base portion forms a metal-to-metal second seal with the belt section and material forced out of the metered container will flow through the neck, past the head, into the third opening and not past the second seal.

2. The valve assembly of claim 1, wherein the distal end of the head flairs out to provide a frustoconical contact surface that is inclined to the longitudinal axis of the valve element.

3. The valve assembly of claim 2, wherein the distal end of the neck flairs outward to provide a frustoconical stop surface to meet the contact surface of the head when the valve element is in the retracted position.

4. The valve assembly of claim 2, wherein the contact surface is inclined at an angle of about 15° to 85° to the longitudinal axis of valve element.

5. The valve assembly of claim 2, wherein the contact surface is inclined at an angle of about 45° to 75° from the longitudinal axis of valve element.

6. The valve assembly of claim 3, wherein the contact surface is inclined at an angle of about 45° to 75° from the longitudinal axis of valve element.

7. The valve assembly of claim 2, wherein the cross sectional length of the contact surface is about 0.0.01 to 0.7 inches.

8. The valve assembly of claim 6, wherein the cross sectional length of the contact surface is about 0.01 to 0.7 inches

9. The valve assembly of claim 1, wherein the head is formed with stainless steel with a Rockwell hardness over about 20 Rc.

10. The valve assembly of claim 1, wherein the outer surface of the head has a smoothness of at least about 24 RMS.

11. The valve assembly of claim 2, wherein the contact surface and stop surface meeting the contact surface have a smoothness of at least about 24 RMS.

12. The valve assembly of claim 1, wherein the inner surface of the belt and outer surface of the base in contact with the belt when the valve element is in the extended condition, have a Rockwell hardness over about 20 Rc and a smoothness of at least about 24 RMS.

13. The valve assembly of claim 1, wherein the metered container includes a piston operatively coupled to a drive to move the piston in the container to increase and decrease the volume of the container in fluid communication with the second opening.

14. The valve assembly of claim 1, wherein the proximal end of the valve element is operatively coupled to a compressed air source to displace the valve element between the extended and retracted positions.

15. The valve assembly of claim 1, wherein the inner surface of the belt and the outer surface of the base meeting the belt when the valve element is in the extended condition have a clearance no more than about 0.06 inches.

16. The valve assembly of claim 1, wherein the inner surface of the belt and outer surface of the base meeting the belt when the valve element is in the extended condition have a clearance no more than about 0.0005 inches to 0.01 inches

17. The valve assembly of claim 1, wherein the material has a viscosity over 10,000 cp.

18. The valve assembly of claim 1, wherein the valve element, neck and belt are dimensioned and arranged so that the valve element always seals the first opening, the third opening or both the first and third openings, whereby the first and third openings are not simultaneously unsealed.

19. A valve assembly for dispensing metered quantities of high viscosity fluids into containers, comprising:
a valve element with a longitudinal axis having a head portion formed with metal and having an end that flairs out to provide a frustoconical contact surface that is inclined to the longitudinal axis of the valve element at an angle of about 15° to 85° to the longitudinal axis of the valve element, the contact surface having a Rockwell hardness over about 20 Rc; and
a stop surface meeting the contact surface to form a metal-to-metal seal.

20. The valve assembly of claim 19, wherein the contact surface and stop surface have a smoothness of at least about 24 RMS.

21. The valve assembly of claim 19, wherein the contact surface is inclined at an angle of about 45° to 75° from the longitudinal axis of valve element.

22. The valve assembly of claim 19, including material having a viscosity over 10,000 cp.
